(19) United States
(12) Patent Application Publication
(10) Pub. No.: US 2012/0080013 A1
(43) Pub. Date: Apr. 5, 2012

(54) HIGH PRESSURE PUMP AND TAPPET ASSEMBLY

(75) Inventors: Gerhard Meier, Schorndorf (DE); Namik Karaosmanoglu, Stuttgart (DE)

(73) Assignee: ROBERT BOSCH GMBH, Stuttgart (DE)

(21) Appl. No.: 13/257,360

(22) PCT Filed: Jan. 20, 2010
(86) PCT No.: PCT/EP2010/050612

§ 371 Date: Dec. 12, 2011

(30) Foreign Application Priority Data
Mar. 18, 2009 (DE) 10 2009 001 631.7

(51) Int. Cl. F02M 37/06; F16H 53/06

(52) U.S. Cl. 123/495; 74/569

(57) ABSTRACT

The invention relates to a high pressure pump for a fuel injection device of an internal combustion engine, comprising at least one pump element having a pump piston delimiting a pump working chamber, wherein between the pump piston and a rotationally driven drive shaft of the high pressure pump, a tappet assembly having a tappet body and a roller shoe pressed into a receptacle of the tappet body is provided, wherein the tappet body comprises a centering guide for pressing in the roller shoe. The invention further relates to a tappet assembly for a high pressure pump for a fuel injection device of an internal combustion engine comprising a tappet body and a roller shoe pressed into a receptacle of the tappet body, wherein the tappet body comprises a centering guide for pressing in the roller shoe.

### BACKGROUND OF THE INVENTION

The present invention relates to a high-pressure pump for a fuel injection device of an internal combustion engine, and to a tappet assembly for a high-pressure pump.

High-pressure pumps for fuel injection devices of internal combustion engines, which high-pressure pumps have a tappet assembly with a roller shoe pressed into a tappet body, are known in the prior art. Here, the tappet assembly is driven in a reciprocating movement, for example counter to the force of a restoring spring, by a drive shaft, which is driven in rotation, of the high-pressure pump.

DE 103 45 061 A1 describes a high-pressure pump having at least one tappet assembly which in turn has a hollow cylindrical tappet body and a roller shoe, in which a roller is rotatably mounted, inserted into said tappet body in the direction of the longitudinal axis of the tappet body. The high-pressure pump has at least one pump element, which in turn has a pump piston by means of which a pump working chamber is delimited. The tappet assembly is arranged between the pump piston and a drive shaft, which is driven in rotation, of the high-pressure pump, wherein the drive shaft has at least one cam or eccentric on which the roller runs. The tappet body is guided in a movable manner in a bore of a housing part of the high-pressure pump. The tappet assembly serves to convert the rotational movement of the drive shaft into a stroke movement of the pump piston. In the tappet assembly described above, the roller shoe is pressed into the tappet body.

Since the tappet assembly must reliably absorb primarily lateral forces acting perpendicular to the axis of rotation of the roller and of the drive shaft, all the components must be formed with very narrow production tolerances.

Owing to the required tolerances of the tappet assembly, however, oblique pressing-in often occurs during the pressing of the roller shoe into the tappet body. This in turn leads to disadvantageous or incorrect pressing-in and/or retaining forces of the interference fit assembly composed of roller shoe and tappet body.

It is therefore necessary to provide a high-pressure pump having a tappet assembly, which has a robust tappet assembly interference fit, in which precise and improved pressing of the roller shoe into the tappet body is ensured.

### SUMMARY OF THE INVENTION

According to the invention, there is provided a high-pressure pump for a fuel injection device of an internal combustion engine, which high-pressure pump has at least one pump element with a pump piston which delimits a pump working chamber, wherein a tappet assembly having a tappet body and having a roller shoe pressed into a receptacle of the tappet body is provided between the pump piston and a drive shaft, which is driven in rotation, of the high-pressure pump, wherein the tappet body has a centering guide for the pressing-in of the roller shoe. Improved pressing of the roller shoe into the tappet body is made possible by the provision, according to the invention, of the centering guide. Oblique pressing-in is avoided, automatic centering is attained by means of the centering guide, and in this way a robust tappet assembly interference fit assembly is realized. Furthermore, the pressing-in forces are not distorted if the tappet body is provided with a centering guide.

The centering guide is preferably provided in the region of the receptacle.

In a further preferred embodiment, the receptacle is formed in the shape of a segment of a cylinder, wherein the receptacle has an inner circumference on which the centering guide is provided.

In yet a further preferred embodiment, the centering guide has a bevel.

The receptacle preferably has a first end section and a second end section, wherein a stop or projection is provided on the second end section so as to project radially inwardly from the inner circumference of the latter, and wherein the first end section faces an element of the drive shaft, in particular a cam or an eccentric.

It is even more preferable if the centering guide is provided on the first end section.

In a further preferred embodiment, the centering guide is provided over a height of the first end section in a range of 2 to 10 mm, in particular of 4 mm.

It is furthermore preferable for the bevel to have a depth a in the range from 0.1 to 0.01 mm, in particular of 0.05 mm, and to be formed in an angle range from 30 to 60°, in particular with an angle of 45°. A weakening of the tappet body by a centering guide with the above dimensions or in the above dimensional ranges has no adverse effects on the tappet assembly interference fit assembly. The axial spacing between the tappet body and the roller shoe is not adversely affected in the tappet assembly, during the pressing-in or during a release of pressure after the pressing-in, in relation to a tappet assembly without a centering guide, nor does a centering guide with the above-specified dimensions have an adverse effect on the radial deformation of the tappet body during the pressing-in and during subsequent release of pressure. In fact, more expedient deformation of the tappet body is obtained in the case of the tappet body with centering guide.

The roller shoe is preferably formed with a cylindrical interference fit oversize which has in particular a value IF_{o,nominal} of 9 μm.

According to the invention, there is furthermore provided a tappet assembly for a high-pressure pump for a fuel injection device of an internal combustion engine, having a tappet body and having a roller shoe which is pressed into a receptacle of the tappet body, wherein the tappet body has a centering guide for the pressing-in of the roller shoe. As a result of the provision of the centering guide, the tappet assembly is robust and has the advantages already described above.

### BRIEF DESCRIPTION OF THE DRAWINGS

Exemplary embodiments of the invention are described in more detail below with reference to the appended drawings, in which:

FIG. 1 shows a longitudinal section through a high-pressure pump according to the prior art;

FIG. 2 shows a detail II of the tappet assembly of the high-pressure pump from FIG. 1;

FIGS. 3A, 3B, 3C show in each case a detail of a tappet assembly according to the prior art before, during and after the pressing-in process;

FIGS. 4A, 4B, 4C show in each case a detail of a tappet assembly according to one embodiment before, during and after the pressing-in process;

FIG. 5A shows a detail view of the installation situation shown in FIG. 3A;

FIG. 5B shows a detail view of the installation situation shown in FIG. 4A; and

FIG. 6 shows a further detail view of the installation situation shown in FIG. 5B.

### EMBODIMENTS OF THE INVENTION

### Detailed Description

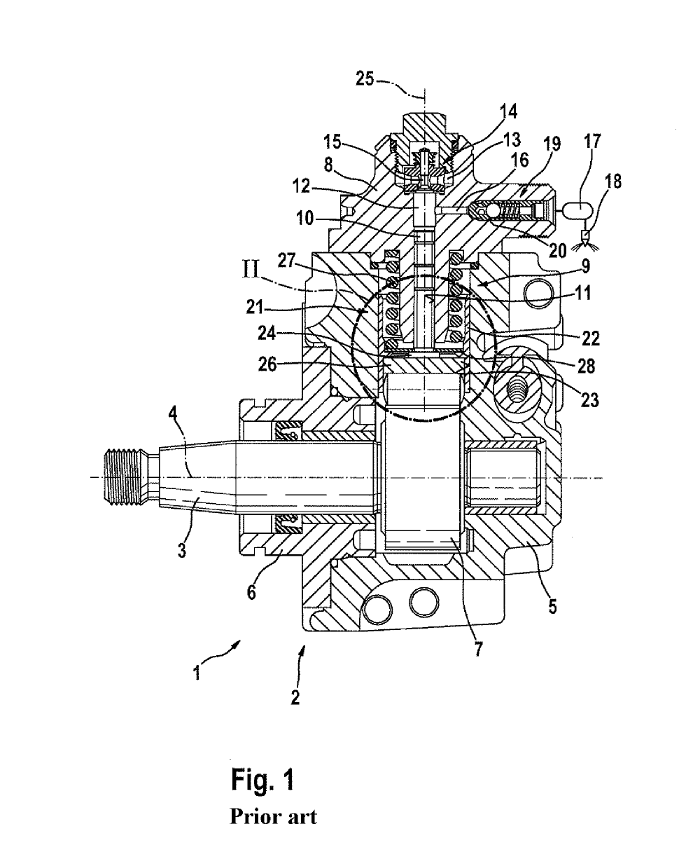

FIG. 1 illustrates a high-pressure pump 1 for a fuel injection device of an internal combustion engine. The high-pressure pump 1 has a housing 2 which is formed in a plurality of parts and in which is arranged a drive shaft 3, which is driven in rotation. The drive shaft 3 is rotatably mounted in the housing 2 by means of two bearing points which are spaced apart from each other in the direction of the axis of rotation 4 of the drive shaft 3. The bearing points may be arranged in different housing parts 5, 6 of the housing 2.

In a region situated between the two bearing points, the drive shaft 3 has at least one cam 7 or eccentric, wherein the cam 7 may also be designed as a multiple cam. The high-pressure pump 1 has at least one or more pump elements 9 which are arranged in in each case one housing part 8 and which have in each case one pump piston 10, which is driven by the cam 7 of the drive shaft 3 indirectly in a stroke movement in an at least approximately radial direction with respect to the axis of rotation 4 of the drive shaft 3. The pump piston 10 is guided in a sealingly movable fashion in a cylinder bore 11 in the housing part 8 and, with its end side facing away from the drive shaft 3, delimits a pump working chamber 12 in the cylinder bore 11.

The pump working chamber 12 has, via a fuel inflow duct 13 which runs in the housing 2, a connection to a fuel inflow for example of a delivery pump. At the mouth of the fuel inflow duct 13 into the pump working chamber 12, there is arranged an inlet valve 14 which opens into the pump working chamber 12 and which has a spring-loaded valve member 15. The pump working chamber 12 furthermore has, via a fuel outflow duct 16 which runs in the housing part 8, a connection to an outlet which is connected for example to a high-pressure accumulator 17. One or preferably several injectors 18 arranged at the cylinders of the internal combustion engine are connected to the high-pressure accumulator 17, through which injectors fuel is injected into the cylinders of the internal combustion engine. At the mouth of the fuel outflow duct 16 into the pump working chamber 12, there is provided an outlet valve 19 which opens out of the pump working chamber 12 and which likewise has a spring-loaded valve member 20.

The pump element 9 is assigned a tappet assembly 21 via which the pump piston 10 is supported on the cam 7 of the drive shaft 3. The tappet assembly 21 comprises a hollow cylindrical tappet body 22 which is movably guided in a bore 23 of a part 5 of the housing 2 of the high-pressure pump 1. The pump piston 10 has a smaller diameter than the tappet body 22 and, with its end region facing away from the pump working chamber 12, projects out of the cylinder bore 11 and into the tappet body 22. At its end facing away from the pump working chamber 12, the pump piston 10 may have a piston foot 24 which is of larger diameter than the remaining region thereof.

The tappet assembly 21 and the pump piston 10 are pressed toward the cam 7 of the drive shaft 3 by a preloaded spring 27. The spring 27 is designed as a helical compression spring which surrounds the pump piston 10 and which projects into the tappet body 22. The spring 27 is supported at one side against the pump housing part 8 and at the other side against a plate spring 28.

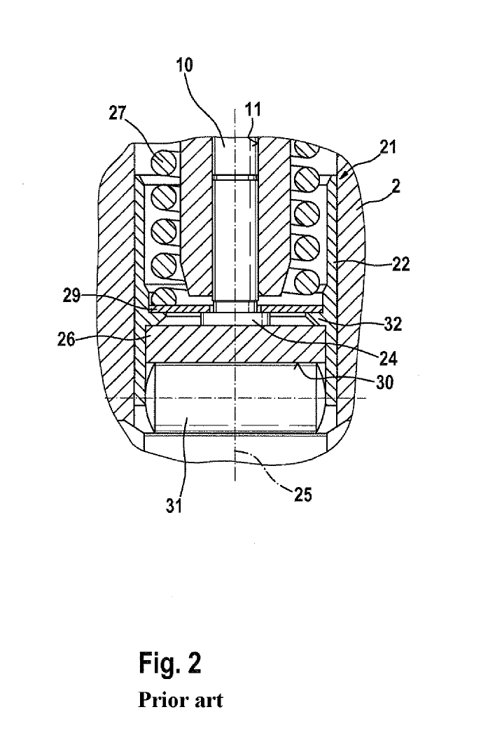

FIG. 2 shows a detail, denoted in FIG. 1 by II, of the tappet assembly 21 of the high-pressure pump 1 from FIG. 1 as per the prior art. As can be seen from the figure, the plate spring 28 is connected to the pump piston 10 and bears against that side of the annular web 29 which faces away from the roller shoe 26. The spring 27 therefore acts via the plate spring 28 both on the pump piston 10 and also on the tappet body 22.

A roller shoe 26 is inserted into the tappet body 22, from that side of the latter which faces toward the drive shaft 3, in the direction of the longitudinal axis 25 of the tappet body 22. In the roller shoe 26, a cylindrical roller 31 is rotatably mounted in a receptacle 30, which is in the shape of a segment of a cylinder, on that side of the roller shoe 26 which faces toward the cam 7 of the drive shaft 3. In the tappet body 22, the roller shoe 26 comes into contact, in the direction of the longitudinal axis 25, against a stop 32 which is formed for example by an annular web which projects radially inward from the tappet body 22.

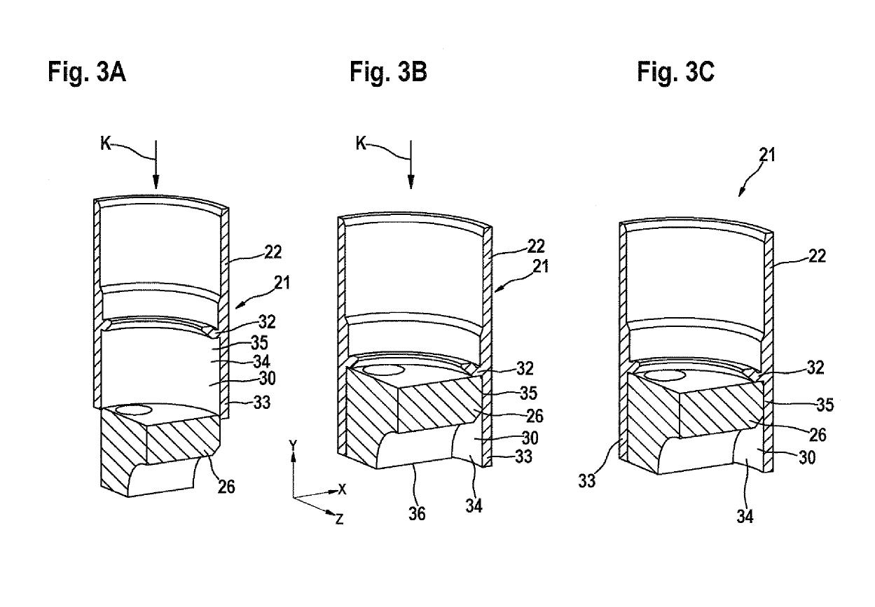

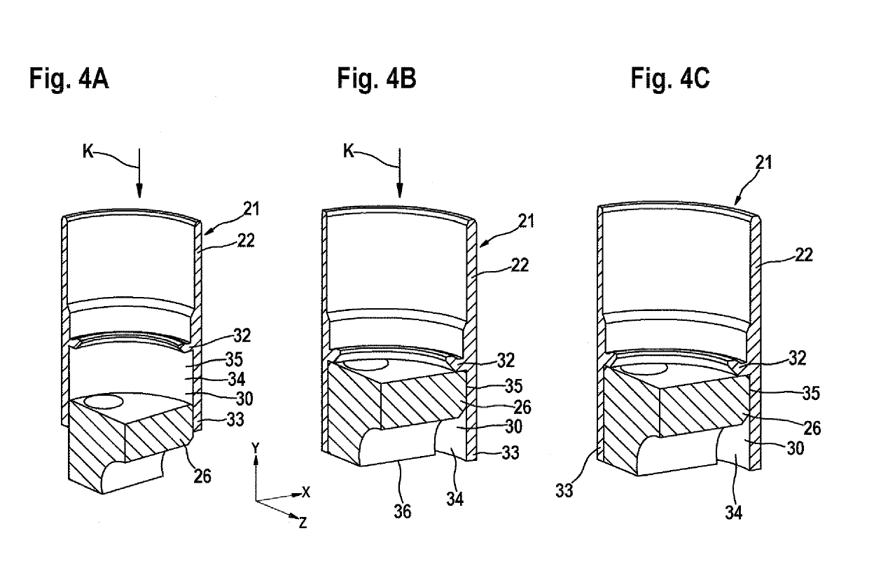

FIGS. 3A, 3B, 3C show in each case a detail of a tappet assembly 21 according to the prior art before, during and after the pressing-in process. FIGS. 4A, 4B, 4C show in each case a detail of a tappet assembly 21 according to one embodiment before, during and after the pressing-in process, wherein the receptacle 30 of the tappet body 22 is provided with a centering guide, described in more detail further below.

FIG. 3A shows an initial stage before the actual pressing-in process, in which a low force K is imparted vertically from above, or in the Y direction, to the tappet body 22 in order to bring the latter into contact with the roller shoe 26. In comparison with the corresponding initial stage, which can be seen in FIG. 4A in the case of a tappet body 22 provided with a centering guide which will be described further below in conjunction with FIG. 6, the roller shoe 26 is already guided into a first end section 33 of the receptacle 30 of the tappet body 22 under the action of an identical low force K imparted to the tappet body 22 in the Y direction. Already in this initial stage, there is a considerably higher pressing-in force or retaining force between the tappet body 22 and the roller shoe 26 in the embodiment than there is in the corresponding initial stage in the case of the tappet body 22 without a centering guide, and the roller shoe 26, according to the prior art.

FIG. 3B and FIG. 4B, by contrast, show in each case a situation during the actual pressing-in process, in which a considerably higher force K of 6 kN is imparted to the tappet body 22 in the Y direction. As a result of the imparting of the force K for example of a magnitude of 6 kN, the roller shoe 26 is guided or pressed into the tappet body 22 along an inner circumference 34 of the receptacle 30 thereof, until the roller shoe 26 abuts against the stop 32 which is provided on a second end section 35 of the receptacle 30. Finally, FIGS. 3C and 4C show a situation in which the roller shoe 26 has been pressed into the receptacle 30 of the tappet body 22 and no further force is imparted to the tappet body 22 in the Y direction.

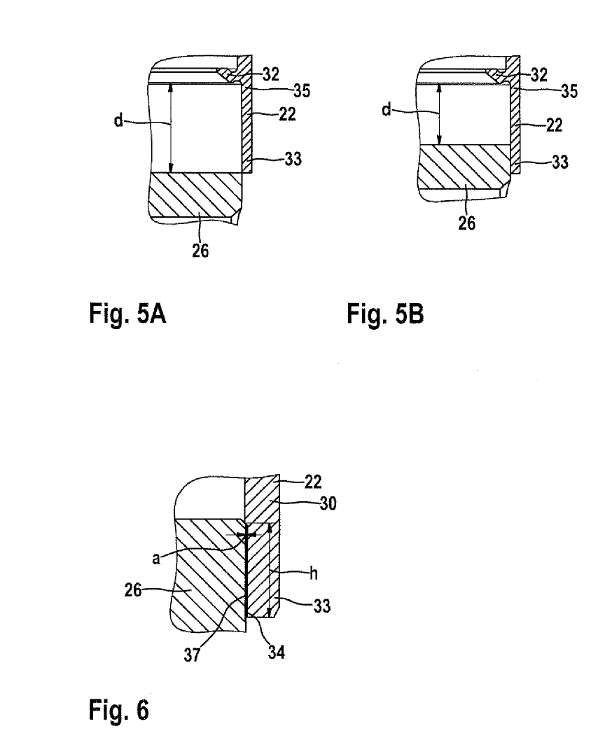

FIG. 5A again shows a detail view of the initial stage illustrated in FIG. 3A, in which the tappet body 22 is brought into contact with the roller shoe 26 by means of the introduction of a low force. Here, a spacing d between the stop 32 on the second end section 35 of the receptacle 30 and the first end section 33 is 11.8 mm. In contrast, as shown in FIG. 5B, in the corresponding initial stage of the pressing-in process of a roller shoe 26 into a tappet body 22 provided with a centering guide, according to the embodiment (see FIG. 4A), the spacing d has already been reduced to 7.8 mm, wherein the same force K is imparted to the tappet body 22 as in the installation situation shown in FIG. 5A.

FIG. 6 shows a further detail view of the installation situation illustrated in FIG. 5B. A centering guide 37 is formed on the inner circumference 34 on the lower end section 33 of the receptacle 30 of the tappet body 22 over a height h of the receptacle 30 of 4 mm. The centering guide provided on the inner circumference 34 has a bevel a of 0.05 mm and an angle of 45°, as a result of which it is made possible for the roller shoe 26 to be guided into the receptacle 30 already during the initial stage over the height h of the centering guide 37 (see FIGS. 4A, 5B).

Viewed overall, a robust tappet assembly 21 or a robust high-pressure pump 1 can be realized as a result of the provision of the centering guide 37. The dimensions of the centering guide 37 do not cause any disadvantageous weakening of the tappet body. Also, the behavior between the tappet body and the roller shoe with regard to the axial spacing between them, or with regard to the radial deformation of the tappet body in an initial stage, during the pressing-in process itself or during the subsequent release of load, is not adversely affected in relation to a tappet body-roller shoe interference fit assembly without centering guide, as per the prior art.

1. A high-pressure pump (1) for a fuel injection device of an internal combustion engine, which high-pressure pump has at least one pump element (9) with a pump piston (10) which delimits a pump working chamber (12), wherein a tappet assembly (21) having a tappet body (22) and having a roller shoe (26) pressed into a receptacle (30) of the tappet body (22) is provided between the pump piston (10) and a drive shaft (3), which is driven in rotation, of the high-pressure pump (1), characterized in that the tappet body (22) has a centering guide (37) for the pressing-in of the roller shoe (26).

2. The high-pressure pump (1) as claimed in claim 1, characterized in that the centering guide (37) is provided in the region of the receptacle (30).

3. The high-pressure pump as claimed in claim 1, characterized in that the receptacle (30) is formed in the shape of a segment of a cylinder, wherein the receptacle (30) has an inner circumference (34) on which the centering guide (37) is provided.

4. The high-pressure pump (1) as claimed in claim 1, characterized in that the centering guide (37) has a bevel.

5. The high-pressure pump (1) as claimed in claim 1, characterized in that the receptacle (30) has a first end section (33) and a second end section (35), wherein a stop (32) is provided on the second end section (35) so as to project radially inwardly from the inner circumference (34) of the latter, and wherein the first end section (33) faces an element of the drive shaft (3).

6. The high-pressure pump (1) as claimed in claim 5, characterized in that the centering guide (37) is provided on the first end section (33).

7. The high-pressure pump (1) as claimed in claim 5, characterized in that the centering guide (37) is provided over a height h of the first end section (33) in a range of 2 to 10 mm.

8. The high-pressure pump (1) as claimed in claim 4, characterized in that the bevel has a depth a in a range of 0.1 to 0.01 mm, and is formed in an angle range from 30 to 60°.

9. The high-pressure pump (1) as claimed in claim 1, characterized in that the roller shoe (26) is formed with a cylindrical interference fit oversize IF_{o,nominal}.

10. A tappet assembly (21) for a high-pressure pump (1) for a fuel injection device of an internal combustion engine, having a tappet body (22) and having a roller shoe (26) which is pressed into a receptacle (30) of the tappet body (22), characterized in that the tappet body (22) has a centering guide (37) for the pressing-in of the roller shoe (26).

11. The high-pressure pump (1) as claimed in claim 1, characterized in that the receptacle (30) has a first end section (33) and a second end section (35), wherein a stop (32) is provided on the second end section (35) so as to project radially inwardly from the inner circumference (34) of the latter, and wherein the first end section (33) faces a cam (7) or an eccentric of the drive shaft (3).

12. The high-pressure pump (1) as claimed in claim 5, characterized in that the centering guide (37) is provided over a height h of the first end section (33) of 4 mm.

13. The high-pressure pump (1) as claimed in claim 4, characterized in that the bevel has a depth of 0.05 mm, and is formed in an angle of 45°.

14. The high-pressure pump (1) as claimed in claim 1, characterized in that the roller shoe (26) is formed with a cylindrical interference fit oversize IF_{o,nominal} of 9 μm.

15. The high-pressure pump as claimed in claim 2, characterized in that the receptacle (30) is formed in the shape of a segment of a cylinder, wherein the receptacle (30) has an inner circumference (34) on which the centering guide (37) is provided.

16. The high-pressure pump (1) as claimed in claim 15, characterized in that the centering guide (37) has a bevel.

17. The high-pressure pump (1) as claimed in claim 16, characterized in that the receptacle (30) has a first end section (33) and a second end section (35), wherein a stop (32) is provided on the second end section (35) so as to project radially inwardly from the inner circumference (34) of the latter, and wherein the first end section (33) faces an element of the drive shaft (3).

18. The high-pressure pump (1) as claimed in claim 17, characterized in that the centering guide (37) is provided on the first end section (33).

19. The high-pressure pump (1) as claimed in claim 18, characterized in that the centering guide (37) is provided over a height h of the first end section (33) in a range of 2 to 10 mm.

20. The high-pressure pump (1) as claimed in claim 19, characterized in that the bevel has a depth a in a range of 0.1 to 0.01 mm, and is formed in an angle range from 30 to 60°.

21. The high-pressure pump (1) as claimed claim 20, characterized in that the roller shoe (26) is formed with a cylindrical interference fit oversize IF_{o,nominal}.
